(19) United States
(12) Patent Application Publication
(10) Pub. No.: US 2011/0140988 A1
(43) Pub. Date: Jun. 16, 2011

(54) Multifunctional Antenna Module For Use with a Multiplicity of Radiofrequency Signals

(75) Inventors: Enrico Toniolo, Vicenza (IT); Davide Amatori, Fara Vicentino (IT)

(73) Assignee: CALEARO ANTENNE S.P.A., Milano (IT)

(21) Appl. No.: 12/937,011

(22) PCT Filed: Apr. 29, 2009
(86) PCT No.: PCT/IB2009/051737

§ 371 Date: Nov. 9, 2010

(30) Foreign Application Priority Data
Apr. 29, 2008 (IT) PD2008A000132

(51) Int. Cl. H01Q 21/00

(52) U.S. Cl. 343/893

(57) ABSTRACT

An antenna module for receiving a multiplicity of radiofrequency signals comprises a first patch antenna (2) with a second patch antenna (3) disposed above it. The first patch antenna (2) comprises a first dielectric substrate (4) having a top surface (5) with a first antenna structure (6) made of a first electrically conductive layer (7) laying thereon, and a bottom surface (8) with a second layer of electrically conductive material (9) thereon. The second patch antenna (3) comprises a second dielectric substrate (10) having a top surface (11) with a second antenna structure (12) made of a third electrically conductive layer (13) laying thereon, and a bottom surface (14) with a fourth layer of electrically conductive material (15) thereon. One of the first (6) and second antenna structures (12) has a substantially circular or elliptical surface, and the other has a substantially polygonal surface.

### FIELD OF THE INVENTION

The present invention finds application in the field of antennas for vehicles or movable means of transport and relates to an antenna module for receiving a multiplicity of radiofrequency signals.

Particularly, the present invention discloses an antenna module comprising two or more microstrip antennas, also known as patch antennas, which are particularly suitable for receiving and/or transmitting satellite band radiofrequency signals.

### BACKGROUND ART

There is a well-known need, particularly in vehicles, of using a plurality of antennas adapted to receive and/or transmit radiofrequency signals in various frequency bands.

Particularly, these antennas may be adapted to receive and/or transmit AM, FM, DAB, TV, GPS, GSM, UMTS band signals and others. These antennas are often arranged close to each other to minimize space requirements and allow them to be enclosed in a single casing.

A particular type of radiofrequency signals are those for satellite applications. These signals have frequencies above 1 GHz and the most suitable antennas to receive them are generally patch antennas.

These generally comprise a dielectric substrate having a top surface with an antenna structure made of an electrically conductive layer laying thereon, and a bottom surface with another layer of electrically conductive material thereon.

These antennas also have an antenna connector, also known as “feed”, extending therethrough.

The signal frequencies that the patch antenna can handle are essentially determined by the shape and size of the electrically conducting layer that forms the antenna structure and is generally made of metal, as well as the size and type of the dielectric substrate.

Nevertheless, this type of antennas is suitable for use with signals belonging to a rather narrow frequency band.

Based on their operation, patch antennas may be divided into two large classes.

The first class includes patch antennas in which the electrically conductive layer has a substantially polygonal, particularly square or rectangular plan shape. In this type of antennas, the modes, i.e. the resonance frequencies, are integer multiples of the fundamental frequency. Also, the latter is directly related to the larger size of the polygon that forms the surface of the antenna structure.

Particularly, patch antennas whose antenna structure has a polygonal surface may be studied both as resonant cavities and as open transmission lines. In both cases, the fundamental frequency of the signals that the antenna can handle may be determined by the following well-known formula:

$$L = \frac{λ}{2 \sqrt{{ɛ}_{eff}}} \qquad ( 1 )$$

Thus, the fundamental wavelength of the signals that can be handled by the antenna is twice the length of the larger dimension of the polygon, with a correction factor related to the dielectric constant of the substrate. Furthermore, this type of antenna, as mentioned above, can also receive all integer harmonics, i.e. all signals having a frequency that is an integer multiple of the fundamental frequency.

In the second class of antennas, the electrically conductive layer has a substantially circular or elliptical plan shape. In this case, resonance modes, i.e. resonance frequencies, are non-integer multiples of the fundamental frequency.

Namely, a patch antenna of this type may be only studied as a resonant cavity. The fundamental frequency of the signals that this antenna can handle may be determined by the following well-known formula:

$$d = \frac{{X}_{0}^{′} λ}{π \sqrt{{ɛ}_{r}}} \qquad ( 2 )$$

where d is the diameter of the circle or the longer axis of the ellipse, and X′₀ is the zero of the Bessel function for the antenna structure.

Thus, the fundamental wavelength of the antenna is related to the diameter or longer axis of the surface of the antenna structure by a coefficient that depends on the patch antenna as a whole. Furthermore, it has already been explained that these antennas are adapted to cut off, i.e. not handle, all integer harmonics, i.e. all signals having a frequency that is an integer multiple of the fundamental frequency, and to handle non-integer harmonics, i.e. signals having a frequency that is a non-integer multiple of the fundamental frequency.

Concerning vehicle applications, multiple antennas are known to be mounted to various locations of the vehicle, for various different uses. If patch antennas are used, these are generally inserted in antenna modules with separate elements in side-by-side relationship, which requires a larger space. Furthermore, an adequate mutual decoupling is required to ensure perfect operation of the individual antenna elements.

A number of embodiments of antenna modules with stacked patch antennas have been provided in the art for size reduction purposes. Examples thereof are disclosed in U.S. Pat. No. 5,121,127 and U.S. Pat. No. 4,089,003, which describe stacked patch antennas whose antenna structures have a circular surface, and in EP 521384, which describes stacked patch antennas whose antenna structures have a polygonal surface.

Thus, it is known in the art to form antenna modules by stacking patch antennas whose antenna structures have surfaces of the same plan shape, to receive different signals or widen the band in which radiofrequency signals may be received.

Nevertheless, these antenna modules are not suitable to simultaneously cover both applications that require handling of integer harmonics of the fundamental frequency and applications that require such harmonics to be cut off.

Another exemplary prior art antenna module is disclosed in Patent Application EP 1619752. It describes two stacked patch antennas, whose antenna structures are namely of the λ/2 type. This document particularly mentions that the overall size of the upper patch antenna (including the dielectric substrate) is smaller than that of the lower patch antenna, which allows the lower patch antenna to ensure a better RF signal reception, due to its being at least partially exposed.

Nevertheless, if the two applications involve similar frequencies, there is a minimum size difference with the result that the advantage of improved reception is eliminated.

Furthermore, this antenna module also suffers from the drawback of not being suitable to simultaneously cover both applications that require handling of integer harmonics of the fundamental frequency and applications that require such harmonics to be cut off.

### DISCLOSURE OF THE INVENTION

A general object of the present invention is to overcome the above drawbacks, by providing a useful and cost-effective antenna module.

A particular object within the general object anticipated above is to provide an antenna module that can simultaneously serve both applications that require handling of integer harmonics of the fundamental frequency, and applications in which such harmonics must be cut off.

A further object of the present invention is to provide an antenna module that allows handling of the same number of signal frequencies with an upper patch antenna of minimized size, so that the lower patch antenna can be exposed as much as possible, for improved reception and/or transmission of radiofrequency signals.

Yet another object of the present invention is to conceive a particularly small and compact antenna module.

These and other objects, as better explained hereafter, are fulfilled by an antenna module adapted to be secured to a vehicle, as defined in the main claim.

Particularly, the present module comprises at least one first patch antenna, with at least one second patch antenna disposed above it, wherein said at least one first patch antenna comprises a first dielectric substrate having a top surface with a first antenna structure made of a first electrically conductive layer laying thereon, and a bottom surface with a second layer of electrically conductive material thereon, said at least one second patch antenna comprises a second dielectric substrate having a top surface with a second antenna structure made of a third electrically conductive layer laying thereon, and a bottom surface with a fourth layer of electrically conductive material thereon, characterized in that at least one of said first and said second antenna structures has a substantially circular or elliptical surface, and the other of said first and said second antenna structures has a substantially polygonal surface.

The combination of at least one patch antenna having an antenna structure with a circular or elliptical surface and at least one patch antenna having an antenna structure with a polygonal surface is able to serve both applications in which integer harmonics of the fundamental frequency are also required to be received and applications in which such harmonics must be cut off.

It will be also appreciated that the stacked arrangement of multiple patch antennas affords size reduction and can serve a number of applications.

In a preferred embodiment, the second antenna structure has a substantially circular or elliptical surface, whereas the first antenna structure has a substantially polygonal surface.

By this arrangement, the same number of signal frequencies may be handled using an upper patch antenna of reduced size, so that the lower patch antenna can be exposed as much as possible. This is because, considering the same number of signal frequencies to be handled, a patch antenna having a circular antenna structure affords a 16% size reduction as compared with an identical patch antenna having a polygonal antenna structure. Thus, the provision of an antenna structure having a circular surface allows the use of an upper patch antenna of a smaller size than in prior art embodiments that use patch antennas with polygonal antenna structures only. Furthermore, the provision of an antenna structure having a polygonal surface allows the use of a lower patch antenna of a larger size than in prior art embodiments that use patch antennas with circular antenna structures only.

In short, the implementation of such a configuration can maximize the difference between the surface sizes of the lower patch antenna and the upper patch antenna, thereby optimizing the operation of the lower patch antenna.

### BRIEF DESCRIPTION OF THE DRAWINGS

Further characteristics and advantages of the invention will be more apparent upon reading the detailed description of a few preferred, non-exclusive embodiments of the antenna module of the invention, which are described as non-limiting examples with the help of the annexed drawings, in which:

FIG. 1 is a perspective view of an antenna module of the invention.

FIGS. 2 and 3 are exploded views of the antenna module of FIG. 1.

### DETAILED DESCRIPTION OF A PREFERRED EMBODIMENT

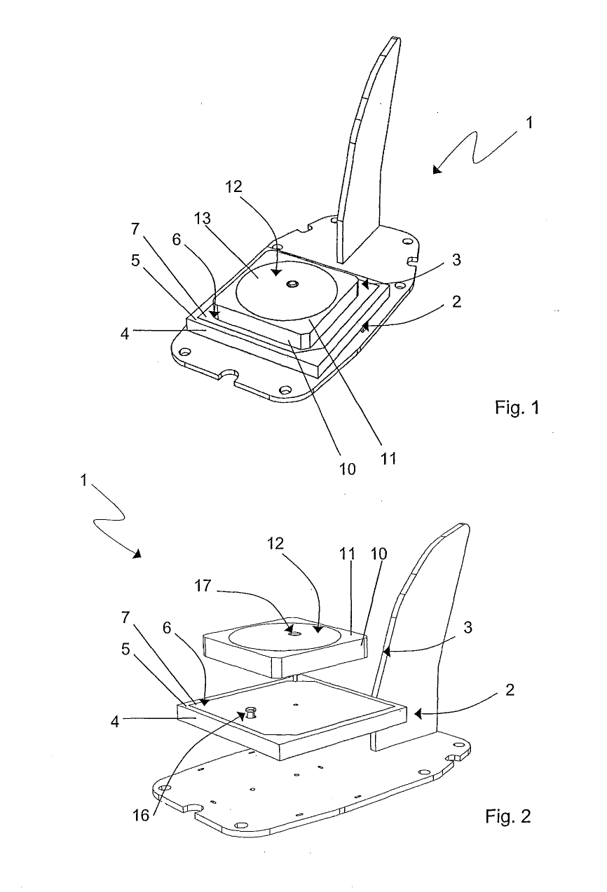

Referring to FIG. 1, there is shown an antenna module 1 of the invention adapted to be secured to a vehicle or similar means of transport.

Particularly, the module 1 comprises a first patch antenna 2, with a second patch antenna 3 disposed thereabove. This embodiment shall be intended merely as an example and not as a limitation to different embodiments, in which there are more than two stacked patch antennas.

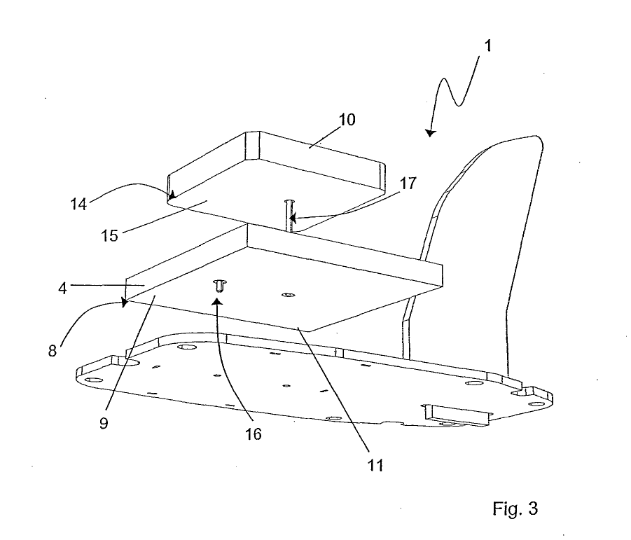

In greater detail, also referring to FIGS. 2 and 3, the first patch antenna 2 is shown to comprise a first dielectric substrate 4 having a top surface 5 with a first antenna structure 6 made of a first electrically conductive layer 7 laying thereon, and a bottom surface 8 with a second layer of electrically conductive material 9 thereon.

Likewise, the second patch antenna 3 comprises a second dielectric substrate 10 having a top surface 11 with a second antenna structure 12 made of a third electrically conductive layer 13 laying thereon, and a bottom surface 14 with a fourth layer of electrically conductive material 15 thereon.

Once again, the embodiment as shown and described herein shall not be intended as a limitation to different embodiments in which there is, for example, more than one antenna structure for each patch antenna.

In one embodiment of the invention, the first patch antenna 2 comprises at least one first antenna connector 16 which extends from the first antenna structure 6 through the first substrate 4. Likewise, the second patch antenna 3 comprises at least one second antenna connector 17 which extends from the second antenna structure 12 through both the second substrate 10 and the first patch antenna 2.

In another aspect of the invention, to be also intended without limitation to different embodiments, the first antenna connector 16 and the second antenna connector 17 are separate from each other. Furthermore, the connection area between the first antenna connector 16 and the first antenna structure 6 is covered by the first patch antenna 3.

According to the invention, at least one of the first 6 and second 12 antenna structures has a substantially circular or elliptical surface, and the other has a substantially polygonal surface.

This arrangement can simultaneously serve both applications in which integer harmonics of the fundamental frequency are also required to be received and applications in which such harmonics must be cut off.

The antenna module 1 disclosed herein is particularly suitable for use in applications that use satellite RF signals. For this purpose, the antenna structure with the substantially polygonal surface is of the λ/2 type.

Particularly, the polygonal surface is preferably but without limitation of square or rectangular shape. In these cases, the length of one side, i.e. the longer side, is half the wavelength that the patch antenna is intended to handle.

In order to still improve the operation of the first patch antenna 2, each of the upper 11 and lower 14 surfaces of the second substrate 10 belonging to the second patch antenna 3 conveniently has a surface extension smaller than that of the first antenna structure 6 belonging to the first patch antenna 2.

An optimization of such aspect is obtained by providing a second antenna structure 12 with a surface of substantially circular or elliptical plan shape and a first antenna structure 6 with a surface of substantially polygonal plan shape. This is because, considering the same number of signal frequencies to be handled, a substantially circular plan shape affords a 16% size reduction as compared with an identical patch antenna having a polygonal antenna structure.

Concerning the first antenna structure 6, its surface area is equal to or smaller than the surface area of the upper surface 5 of the first substrate 4. Likewise, the second antenna structure 12 has a surface area equal to or smaller than the surface area of the upper surface 11 of the second substrate 10.

In another aspect of the invention the second 9 and fourth 15 layers of electrically conductive material are coincident. In fact, this aspect only concerns the practical implementation of the module and does not affect the operation of the stacked patch antennas 2, 3. This is because while the two electrically conductive layers 7, 13, generally obtained by metallization, are separate from each other, they can be assimilated to a single electrically conductive element, considering the signal frequencies handled by the antennas 2, 3.

Therefore, the decision of providing either a single metallization on the lower surface 15 of the second substrate 10 or the upper surface 5 of the first substrate or two distinct metallization only depends on the production process to be implemented.

Conveniently, the diameter of the circle or the longer axis of the ellipse of said second antenna structure 12 having a substantially circular or elliptical plan shape is determined on the basis of the fundamental frequency of the signals to be handled by the antenna, according to the above mentioned formula (2)

$$d = \frac{{X}_{0}^{′} λ}{π \sqrt{{ɛ}_{r}}}$$

where X′₀ is the zero of the Bessel function for the antenna structure.

It will be appreciated from the above that this antenna module fulfils the intended objects and can particularly simultaneously cover both applications that require handling of integer harmonics of the fundamental frequency and applications that require such harmonics to be cut off.

It can be further noted that the present antenna module allows handling of the same number of signal frequencies with an upper patch antenna of reduced and optimized size, so that the lower patch antenna can be exposed as much as possible, thereby improving its reception and/or transmission of radiofrequency signals.

Also, the present module is compact and may be easily inserted in one small protective casing.

The antenna module of the invention is susceptible to a number of changes and variants, within the inventive concept disclosed in the appended claims. All the details thereof may be replaced by other technically equivalent parts, and the materials may vary depending on different needs, without departure from the scope of the invention.

While the antenna module has been described with particular reference to the accompanying figures, the numerals referred to in the disclosure and claims are only used for the sake of a better intelligibility of the invention and shall not be intended to limit the claimed scope in any manner.

1. A multifunctional antenna module for handling a multiplicity of radiofrequency signals, comprising at least one first patch antenna with at least one second patch antenna disposed above it, wherein
said at least one first patch antenna comprises a first dielectric substrate having a top surface with at least one first antenna structure made of a first electrically conductive layer laying thereon, and a bottom surface with a second layer of electrically conductive material thereon;
said at least one second patch antenna comprises a second dielectric substrate having a top surface with at least one second antenna structure made of a third electrically conductive layer laying thereon, and a bottom surface with a fourth layer of electrically conductive material thereon;
wherein at least one of said first and said second antenna structures has a substantially circular or elliptical surface, and the other of said first and said second antenna structures has a substantially polygonal surface.

2. An antenna module as claimed in claim 1, wherein said second antenna structure has a substantially circular or elliptical surface, and said first antenna structure has a substantially polygonal surface.

3. An antenna module as claimed in claim 1, wherein each of said upper and lower surfaces of said second substrate has a surface area smaller than the surface area of said first antenna structure.

4. An antenna module as claimed in claim 1, wherein said first antenna structure, respectively said second antenna structure, has a surface area at most equal to the surface area of said upper surface of said first substrate, respectively of said upper surface of said second substrate.

5. An antenna module as claimed in claim 1, wherein said first patch antenna comprises at least one first antenna connector that extends from said first antenna structure through said first substrate.

6. An antenna module as claimed in claim 5, wherein said second patch antenna comprises at least one second antenna connector that extends from said second antenna structure through said second substrate and said first patch antenna.

7. An antenna module as claimed in claim 6, wherein said first antenna connector and said second antenna connector are separate from each other.

8. An antenna module as claimed in claim 5, wherein the connection area between said first antenna connector and said first antenna structure is covered by said second patch antenna.

9. An antenna module as claimed in claim 1, wherein said second and said fourth layers of electrically conductive material are coincident.

10. An antenna module as claimed in claim 1, wherein the diameter of the circle or the longer axis of the ellipse of said second antenna structure having a substantially circular or elliptical plan shape is determined on the basis of the fundamental frequency of the signals to be handled by the antenna, according to the formula
$$d = \frac{{X}_{o}^{′} λ}{π \sqrt{{ɛ}_{r}}}$$
where X′ₒ is the zero of the Bessel function for the antenna structure.

11. An antenna module as claimed in claim 1, wherein said polygonal surface has a substantially square shape.

12. An antenna module as claimed in claim 1, wherein said polygonal surface has a substantially rectangular shape.
